(19) United States
(12) Patent Application Publication
(10) Pub. No.: US 2010/0093274 A1
(43) Pub. Date: Apr. 15, 2010

(54) FAULT-TOLERANT NON-RANDOM SIGNAL REPEATING SYSTEM FOR BUILDING ELECTRIC CONTROL

(76) Inventor: Jian Xu, Windsor (CA)

Correspondence Address: Carlson, Gaskey & Olds/Masco Corporation, 400 West Maple Road, Suite 350, Birmingham, MI, 48009, US

(21) Appl. No.: 12/251,695

(22) Filed: Oct. 15, 2008

(51) Int. Cl. H04B 7/15

(52) U.S. Cl. 455/11.1

(57) ABSTRACT

An electric control system comprises a plurality of transceivers. The transceivers are also associated with a control for at least one electrical item. A plurality of electric switches provide a wireless signal to a plurality of the transceivers, each being operable to receive the wireless signal, and retransmit the received signal to be received by others of the transceivers. Each of the transceivers is programmed to retransmit a received signal at a distinct period of time after receipt of the original signal.

### BACKGROUND OF THE INVENTION

This application relates to a method of transmitting signals in a wireless electric system for a building.

Recently, wireless electric devices, such as switches, have been utilized in buildings. These switches communicate wireless signals to a control, which receives the signals and effects commands. One increasingly popular application is the control for lighting and electric power supply in a building.

In one known system, wireless switches can be actuated to send a signal to a receiver, and the receiver can then act on the signals. As an example, the signal may be a request to turn off or dim an electric light associated with the receiver.

In buildings there may be more than one receiver and more than one switch. Each of these several receivers may receive the wireless signal. The several receivers must decide whether the signal is an appropriate one for it to affect a control.

This decision process is complicated by the fact that for aesthetic reasons, the actuation of the lighting control must be made in an extremely short period of time after the actuation of the switch. That is, the user of the building desirably should not see any delay between actuating the switch, and seeing the resultant control, such as a light dimming.

In the prior art, the several receivers would not only receive a signal but each repeat the signal. That is, the receivers also transmit, and are thus transceivers. This repeating is performed to ensure that the appropriate receiver receives the signal. Some receivers may be placed in a location such that they are less likely to receive a signal from an associated switch, and this repeating function is intended to pass the signal to all receivers. In the prior art, the several receivers generate their repeating signals at a random time from the receipt of the original signal.

With the above-referenced systems, there is the possibility of signal collision, and the identification of a proper signal is made more complicated.

### SUMMARY OF THE INVENTION

In a disclosed embodiment of this invention, the several transceivers associated with an electrical control system each re-transmit a received signal at a predetermined period of time after receipt. Thus, each receiver that retransmits a received signal will be at a distinct time, and there will be no data collision. The several received signals can then be evaluated to determine a proper signal.

These and other features of the present invention can be best understood from the following specification and drawings, the following of which is a brief description.

### BRIEF DESCRIPTION OF THE DRAWINGS

FIG. 1 schematically shows an electric control system for a building.

FIG. 2 shows a sample of the signals that are generated when a wireless electric signal is sent.

### DETAILED DESCRIPTION OF THE PREFERRED EMBODIMENT

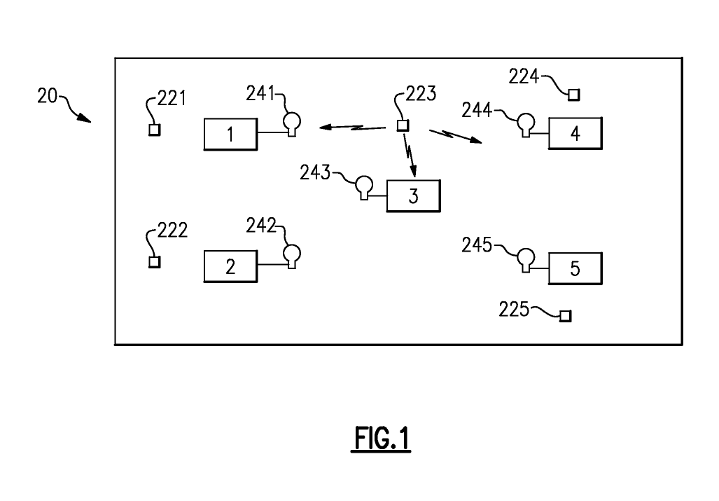

An electric control system 20 is illustrated in FIG. 1. As shown, five transceivers, 1, 2, 3, 4, and 5 may be associated with a building. Each of these transceivers may be a wireless transceiver and electric control such as available from EnOcean under its Product No. TCM200C. Each of the controls 1-5 are operable to receive wireless signals, such as from switches 221, 222, 223, 224, and 225, and then effect control of associated electrical components such as the illustrated lights 241, 242, 243, 244, and 245. The wireless switches may be as known, and available from EnOcean under its Product No. PTM240C. The controls 1-5 are also operable to transmit signals, and thus all could generally be referred to as a transceiver.

It is known in this field that when one of the wireless switches 221-225 sends its signal (shown schematically as switch 223 in FIG. 1), the signal may be received by more than one of the transceivers 1-5. Each of the transceivers retransmits each received signal.

In a main feature of this invention, each of the transceivers 1-5 is programmed to retransmit a received signal at a distinct period of time after receipt. The distinct period of time for each of the transceivers can be generated by a pseudo-random generator to reduce the chances for them to be the same among different buildings. If in fact collisions are still received, then some signal may be provided, as to an occupant of a building including this disclosed system, for example, that the pseudo-random generator should be reactuated to regenerate a distinct period of time for the transceivers. Once the distinct period of time is generated, it is stored and repeated for each of the transceivers thereafter, unless changed.

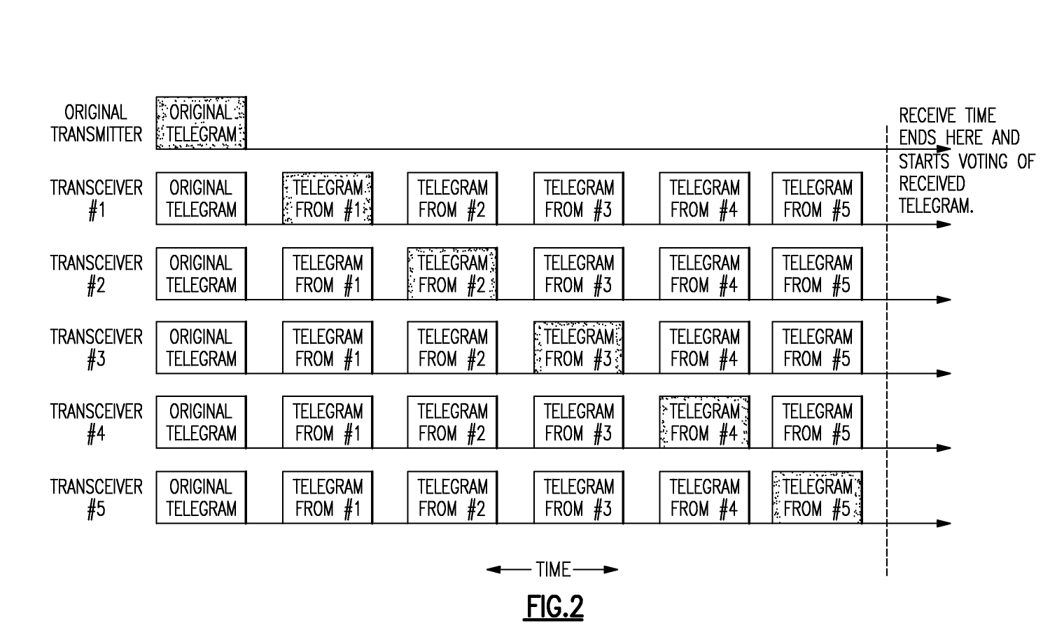

Thus, as shown in FIG. 2, the original signal transmitted from the switch 223 is received at each of the transceivers 1-5. The transceiver 1 will then retransmit its signal or telegram at a first period of time. This signal will be received by the other four controls. Then, the transceiver 2 will transmit its telegram; the transceiver 3 will transmit its telegram; the transceiver 4 will transmit its telegram; and transceiver 5 will then transmit its telegram. Each of these five signals may be received by the other transceivers. The transceivers will each have a non-random fixed retransmission period. At some period of time, each of the transceivers knows that the time for receiving retransmitted signals has ended from the receipt of the original signal. At that point, the received signals can be evaluated. If more than one of the received signals is identical, then a control for each transceiver can determine if it is an appropriate signal. If the signal is for the electric item associated with the receiving transceiver, then that control can act to control the light.

For each transceiver, if there are two received signals each coming from more than one of the transceivers, then a “voting” step will be taken. As an example, if one signal is received from three of the five transceivers and another signal is received from two other transceivers, the signal received from the three transceivers will be taken as the proper signal.

As an example, the light switch 223 has sent a signal to the transceiver 3 to control the light 243. The original signal, and the retransmitted signal, will be received by the transceivers 1, 2, 4, and 5. However, each control will evaluate the signal to see whether it is intended for the control itself. This can be provided by having an identifier in the wireless signal sent from each of the switches 221-225.

The use of the distinct retransmission time for each of the transceivers thus provides a system in which there is no data collision, and in which the appropriate control can quickly act to determine what must be done, and then effect a desired control. The total time as shown in FIG. 2 will be very short, such that an occupant requesting the light dim will notice no delay. The total time should be less than 0.2 seconds.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. An electric control system comprising:
a plurality of transceivers, said transceivers also being associated with a control for at least one electrical item;
a plurality of electric switches, said electric switches providing a wireless signal to a plurality of said transceivers, said transceivers each being operable to receive said wireless signal, and retransmit the received signal to be received by others of the transceivers; and
each of said transceivers being programmed to retransmit a received signal at a distinct period of time after receipt of the wireless signal.

2. The electric control system as set forth in claim 1, wherein said associated electric items includes a light, and said control providing power to the light.

3. The electric control system as set forth in claim 1, wherein a decision is made that a signal is a proper signal if at least two of the received signals are identical.

4. The electric control system as set forth in claim 3, wherein if there are at least two of the received signals which come from at least one of the transceivers, then an identification of a proper signal is taken by a vote amongst the received signals.

5. The electric control system as set forth in claim 1, wherein said distinct periods of time are determined by a pseudo-random generator.

6. A method of operating an electric control system comprising the steps of:
providing a wireless signal from a switch to a plurality of said transceivers, receiving said wireless signal, and retransmitting the received signal to be received by others of the transceivers; and
each of said transceivers retransmitting a received signal at a distinct period of time after receipt of the original signal.

7. The method as set forth in claim 6, wherein said associated electric items includes a light, and said control providing power to the light.

8. The method as set forth in claim 6, wherein a decision is made that a signal is a proper signal if at least two of the received signals are identical.

9. The method as set forth in claim 8, wherein if there are at least two of the received signals which are received by at least one of the transceivers, then an identification of a proper signal is taken by a vote amongst the transceivers.

10. The method as set forth in claim 6, wherein said distinct periods of time are determined by a pseudo-random generator.
